(19) United States
(12) Patent Application Publication
(10) Pub. No.: US 2016/0255964 A1
(43) Pub. Date: Sep. 8, 2016

(54) SPRING WITH VARIABLE RESISTANCE AND MATTRESSES INCLUDING THE SAME

(71) Applicant: Sealy Technology, LLC, Trinity, NC (US)

(72) Inventor: Darin T. Thomas, Salisbury, NC (US)

(73) Assignee: Sealy Technology, LLC, Trininty, NC (US)

(21) Appl. No.: 14/636,473

(22) Filed: Mar. 3, 2015

(51) Int. Cl. A47C 23/02; F16F 3/00

(52) U.S. Cl. CPC A47C 23/02; F16F 3/00

(57) ABSTRACT

A spring provides variable (non-linear) resistance as the spring is compressed. The spring comprises a plurality of spring elements that are stacked atop one another, each spring element comprising a upper member and a lower member connected to the upper member, each spring element defining an internal space between the upper member and the lower member, and each spring element configured to compress when a force is applied to the spring, such that the upper member moves toward the lower member. The spring further comprises one or more spring stops positioned in the internal space defined by on one or more of the plurality of spring elements, each spring stop being configured to prevent the respective spring element from compressing past a predetermined compression distance. A mattress is further provided and includes multiple such springs arranged in a matrix.

### TECHNICAL FIELD

The present invention relates to springs and mattresses including springs. In particular, the present invention relates to variable resistance springs which exhibit a non-linear response when compressed.

### BACKGROUND

Typically, when a uniaxial load is applied to a spring, the spring exhibits a linear compression rate. That is to say, it takes twice as much force to compress a typical spring two inches as it does to compress the same spring one inch. The linear response of springs is expressed by Hooke's law which states the force (F) needed to extend or compress a spring by some distance (D) is proportional to that distance. This relationship is expressed mathematically as F=kD, where k represents the spring constant for a particular spring. A high spring constant indicates that the spring requires more force to compress, and a low spring constant means the spring requires less force to compress.

Spring rate is another well-known value used to categorize springs. The spring rate of a particular spring is the amount of force needed to compress a spring one inch. Springs with a high spring constant also have high spring rates, and springs with low spring constants have low spring rates. Of course, the spring constant and spring rate values are merely an approximation of the real response of a given spring; however, they are an accurate approximation for most springs given reasonable distance (D) values in comparison to the overall dimensions of the spring. Furthermore, Hooke's law applies for a variety of different spring shapes, including, for example, a coil spring, a cantilever spring, a leaf spring, or even a rubber band.

Linear response springs, such as wire coil springs, are commonly used as mattress innersprings in combination with padding and upholstery that surround the innersprings. Most mattress innersprings are comprised of an array of wire coil springs which are often adjoined by lacing end convolutions of the coil springs together with cross wires. An advantage of this arrangement is that it is inexpensive to manufacture. However, this type of innerspring provides a firm and rigid mattress surface.

An alternative to an innerspring mattress is a mattress constructed of one or more foam layers. Unlike an innerspring comprised of an array of wire coil springs, foam mattresses exhibit a non-linear response to forces applied to the mattress. In particular, a foam mattress provides more support as the load increases. For instance, a typical foam mattress provides increased support after it has been compressed approximately 60% of the maximum compression of the foam. The non-linear response of foam mattresses provides improved sleep comfort for a user. However, the mechanical properties of foam degrade over time affecting the overall comfort of the foam mattress. Furthermore, foam mattresses are more costly than metal spring mattresses.

### SUMMARY

The present invention relates to springs that provide variable resistance as the spring is compressed. In particular, the present invention relates to variable resistance springs that are extruded as a single unit and used within a mattress to provide a user positioned on the mattress increased support for portions of the user's body where a higher load is applied to the mattress. Thus, the mattress of the present invention provides a user the non-linear support typically seen in a foam mattress, but through the use of springs.

In one exemplary embodiment of the present invention, a spring includes a plurality of spring elements that are stacked atop one another, each spring element comprising a curved upper member and a curved lower member connected to the curved upper member, such that a concave side of the upper member and a concave side of the lower member define an internal space of the spring element. The spring further includes one or more spring stops positioned within the internal space of one or more of the spring elements.

Each spring element of the exemplary spring acts as a compression spring, such that a force applied to the upper member of the spring causes the upper member to move toward the lower member. Specifically, a force applied to the upper member of a particular spring element causes the upper member and the lower member to partially flatten out, and the internal space of the spring element becomes narrower. When the force is removed from the spring element, both the upper and lower members return to their original shape and position. To this end, the upper and lower members of the spring elements are comprised of a material which allows the upper and lower members to flex when the spring element is compressed, but still provide a biasing force to return the spring element to its original shape.

Each of the plurality of spring elements is connected to an adjacent spring element at a middle portion of the upper member or a middle portion of the lower member. For example, a bottom spring element is connected to the adjacent spring element at the middle portion of the upper member of the bottom spring element, whereas a central spring element is connected to adjacent spring elements at both the middle portion of the upper member as well as the middle portion of the lower member.

The spring stops of the present invention are positioned within the internal space defined by one or more of the spring elements, and such spring stops are configured to prevent the respective spring elements from compressing past a predetermined compression distance. In some embodiments, the spring stops are connected to (and integral with) a middle portion of the concave side of the lower member of the spring element. In some embodiments, each spring stop is a different size, such that the predetermined compression distance is different for each of the spring stops.

In operation, the plurality of spring elements function as a set of springs in series. When the spring is compressed, each spring element compresses simultaneously, unless a spring stop prevents the particular spring element from compressing further. By providing spring stops of different sizes, each spring stop engages its respective spring element at different compression distances of the spring. Accordingly, as the force applied to the spring increases and the compression distance of the spring increases, the number of active spring elements decreases, and the effective spring constant of the spring increases. As the spring constant increases, the spring rate also increases and the spring becomes “harder.” Thus, the spring of the present invention provides a non-linear response to loading.

In some embodiments, the spring also includes a vertical extension that is positioned between two spring elements. Such a vertical extension provides greater spacing between the two spring elements. Including such a vertical extension in the spring provides a point of flexure in the spring for when the spring is asymmetrically loaded, such as would be experienced when the spring is used in an innerspring for a mattress.

In another embodiment of the present invention, a mattress includes a plurality of the exemplary springs of the present invention. The springs are arranged in a matrix, such that a top engagement surface defined by the springs forms a first support surface, and a bottom engagement surface defined by the springs forms a second support surface opposite the first support surface. The mattress also comprises an upper body supporting layer positioned adjacent to the first support surface, along with a lower foundation layer positioned adjacent to the second support surface. Furthermore, a sidewall extends between the upper body supporting layer and the lower foundation layer, and around the entire periphery of the two layers, such that the springs are completely surrounded.

Further features and advantages of the present invention will become evident to those of ordinary skill in the art after a study of the description, figures, and non-limiting examples in this document.

### BRIEF DESCRIPTION OF THE DRAWINGS

FIG. 1 is a perspective view of an exemplary spring, made in accordance with the present invention;

FIG. 2 is perspective view of the exemplary spring of FIG. 1, with the spring compressed a first predetermined distance, D₁;

FIG. 3 is perspective view of the exemplary spring of FIG. 1, with the spring compressed a second predetermined distance, D₂;

FIG. 4 is perspective view of the exemplary spring of FIG. 1, with the spring compressed a third predetermined distance, D₃;

FIG. 5 is an enlarged, partial perspective view of the exemplary spring of FIG. 1, focusing on one spring element of the exemplary spring;

FIG. 6 is graph depicting the forces necessary to maintain compression distances of the exemplary spring of FIG. 1; and

FIG. 7 is a perspective view of an exemplary mattress made in accordance with the present invention, with a portion of the outer layers removed to show the plurality of springs in the mattress.

### DESCRIPTION OF EXEMPLARY EMBODIMENTS

The present invention relates to springs that provide variable resistance as the spring is compressed. In particular, the present invention relates to variable resistance springs that are extruded as a single unit and used within a mattress to provide a user positioned on the mattress increased support for portions of the user's body where a higher load is applied to the mattress. Thus, the mattress of the present invention provides a user the non-linear support typically seen in a foam mattress, but through the use of springs.

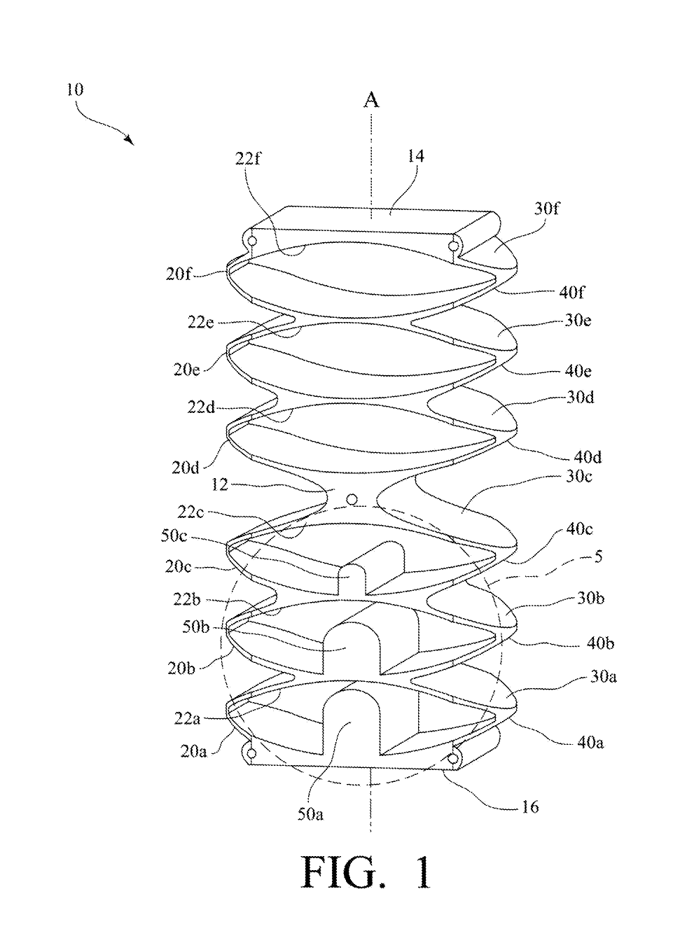

Referring to FIGS. 1-4, in one exemplary embodiment of the present invention, a spring 10 includes a plurality of spring elements 20a-f that are stacked atop one another along an Axis A, with each spring element 20a-f comprising a curved upper member 30a-f and a curved lower member 40a-f connected to the curved upper member 30a-f, such that a concave side of the upper member 30a-f and a concave side of the lower member 40a-f define an internal space 22a-f of the spring element 20a-f. As shown, in this exemplary embodiment, the internal space 22a-f defined by each spring element 20a-20f can be characterized as having a generally elliptical shape (when no force is applied). The spring 10 further includes one or more spring stops 50a-c positioned within the internal space 22a-f defined by one or more of the spring elements 20a-f. In particular, the exemplary spring 10 shown in FIGS. 1-4 includes a first spring element 20a located at the bottom of the spring 10, a sixth spring element 20f located at the top of the spring 10, and second, third, fourth, and fifth spring elements 20b, 20c, 20d, 20e positioned between the first spring element 20a and the sixth spring element 20f. The exemplary spring 10 also includes first, second, and third spring stops 50a, 50b, 50c positioned within the internal space 22a, 22b, 22c defined, respectively, by the first, second, and third spring elements 20a, 20b, 20c (i.e., the bottom three spring elements).

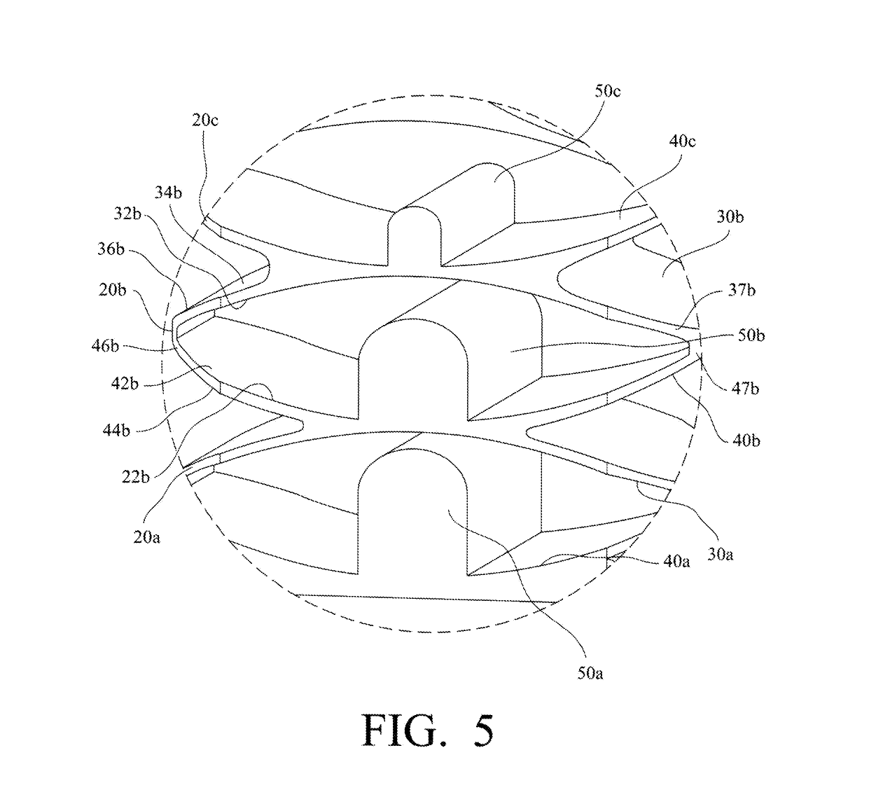

FIG. 5 is an enlarged, partial perspective view of the exemplary spring of FIG. 1, focusing on second spring element 20b of the exemplary spring 10, but the structure and function of all of the spring elements 20a-f is substantially identical. As shown in FIG. 5, the upper member 30b of the second spring element 20b has two parallel outer ends 36b, 37b, with a downward-facing concave side 32b extending between the outer ends 36b, 37b, and an upward-facing convex side 34b opposite the concave side 32b. Similarly, the lower member 40b of the second spring element 20b has two parallel outer ends 46b, 47b, with an upward-facing concave side 42b extending between the outer ends 46b and a downward-facing convex side 44b opposite the concave side 42b. The outer ends 36b, 37b of the upper member 30b are connected to the outer ends 46b, 47b of the lower member 40b, such that the downward-facing concave side 32b of the upper member 30b is facing the upward-facing concave side 42h of the lower member 40b, thus defining the internal space 22b of the second spring element 20b.

Referring to FIGS. 1-5, each spring element 20a-f acts as a compression spring, such that a force applied to the upper member 30a-f of a particular spring element 20a-f causes the upper member 30a-f to move toward the lower member 40a-f. Specifically, a force applied to the upper member 30a-f of a particular spring element 20a-f causes the upper member 30a-f to partially flatten out, with the outer ends (36b, 37b in FIG. 5) of the upper member 30a-f moving away from each other. The movement of the outer ends (36b, 37b in FIG. 5) of the upper member 30a-f causes the outer ends (46b, 47b in FIG. 5) of the lower member 40a-f to also move away from each other, such that the lower member 40a-f will also flatten out. In this way, when a force has been applied to a spring element 20a-f the distance between the concave side (32b in FIG. 5) of the upper member 30a-f and the concave side (42b in FIG. 5) of the lower member 42a-f decreases, and the internal space 22a-f of the spring element 20a-f becomes narrower. When the force is removed from the spring element 20a-f, both the upper and lower members 30a-f, 40a-f return to their original shape and position.

Accordingly, the upper and lower members 30a-f, 40a-f are comprised of a material which allows the upper and lower members 30a-f, 40a-f to flex when the spring element 20a-f is compressed, but still provides a biasing force to return the spring element 20a-f to its original shape. For example, the upper and lower members 30a-f, 40a-f may be comprised of rubber, plastic, metal, or other similar material that exhibits elastic deformation. Furthermore, in this exemplary embodiment, the spring 10 is illustrated as a unitary member, which could be manufactured, for example, by molding or extruding a thermoplastic material.

In view of the manner in which the spring elements 20a-f move in response to the application or removal of a force, each upper member 30a-f and each lower member 40a-f of the spring elements 20a-20f may be characterized as a leaf spring. The upper members 30a-f are downward-facing leaf springs, and the lower members 40a-f are upward-facing leaf springs. In these particular embodiments, the entire spring 10 can thus be considered a vertical stack of alternately stacked upward and downward-facing leaf springs.

Referring still to FIGS. 1-5, each of the plurality of spring elements 20a-f is connected to an adjacent spring element 20a-f at a middle portion on the convex side of the upper member 30a-e or a middle portion on the convex side of the lower member 40b-f. For example, the first spring element 20a is connected to the adjacent second spring element 20b at a middle portion of the convex side of the upper member 30a of the first spring element 20a and a middle portion of the convex side of the lower member 40b of the second spring element 20b. The second spring element 20b is similarly connected to the adjacent third spring element 20c, with the upper member 30b of second spring element 20b connecting to the lower member 40c of third spring element 20c, and so on.

Referring still to FIGS. 1-5, and as mentioned above, in this exemplary embodiment, spring stops 50a-c are positioned within the internal spaces 22a, 22b, 22c defined, respectively, by the first, second, and third spring elements 20a, 20b, 20c (i.e., the bottom three spring elements). These spring stops 50a-c are configured to prevent the respective spring elements 20a-c from compressing past a predetermined compression distance. In this exemplary embodiment, the spring stops 50a-c are connected to (and integral with) a middle portion of the concave side of the lower member 40a-c of the respective spring elements 20a-c; however, the spring stops 50a-c could also be connected to some other portion of each spring element 20a-c without departing from the spirit and scope of the present invention. Furthermore, as shown in FIGS. 1-5, in the exemplary spring 10, each individual spring stop 50a-c is a different size, the importance of which is described in further detail below. In particular, the second spring stop 50b is smaller than the first spring stop 50a, and the third spring stop 50c is smaller than the second spring stop 50b.

Referring now to FIGS. 1-4 and 6, in operation, the plurality of spring elements 20a-f of the spring 10 function as a set of springs in series. The effective spring constant, K_{eff}, for a set of springs in series is the inverse sum of the reciprocals of the spring constants, Kₙ, of the individual springs in series, which is mathematically represented by equation (1) as follows:

$${K}_{eff} = \frac{1}{\frac{1}{{K}_{1}} + \frac{1}{{K}_{2}} + …} \qquad ( 1 )$$

When the exemplary spring 10 is uncompressed, as shown in FIG. 1, the effective spring constant of the spring 10 is the inverse sum of the reciprocals of the spring constants of all of the plurality of spring elements 20a-f. Accordingly, the initial spring constant, K₁, of the spring 10 is represented by equation (2) as follows:

$$K 1 = \frac{1}{\frac{1}{{K}_{a}} + \frac{1}{{K}_{b}} + \frac{1}{{K}_{c}} + \frac{1}{{K}_{d}} + \frac{1}{{K}_{e}} + \frac{1}{{K}_{f}} +} \qquad ( 2 )$$

It is contemplated, however, that the exemplary spring 10 is configured such that the spring constant of each of the plurality of spring elements 20a-f is the same spring constant, K. Accordingly, equation (2) can be simplified, with the initial effective spring constant, of the spring 10 presumed to equal ⅙ of the spring constant, K, of the individual spring elements 20a-f.

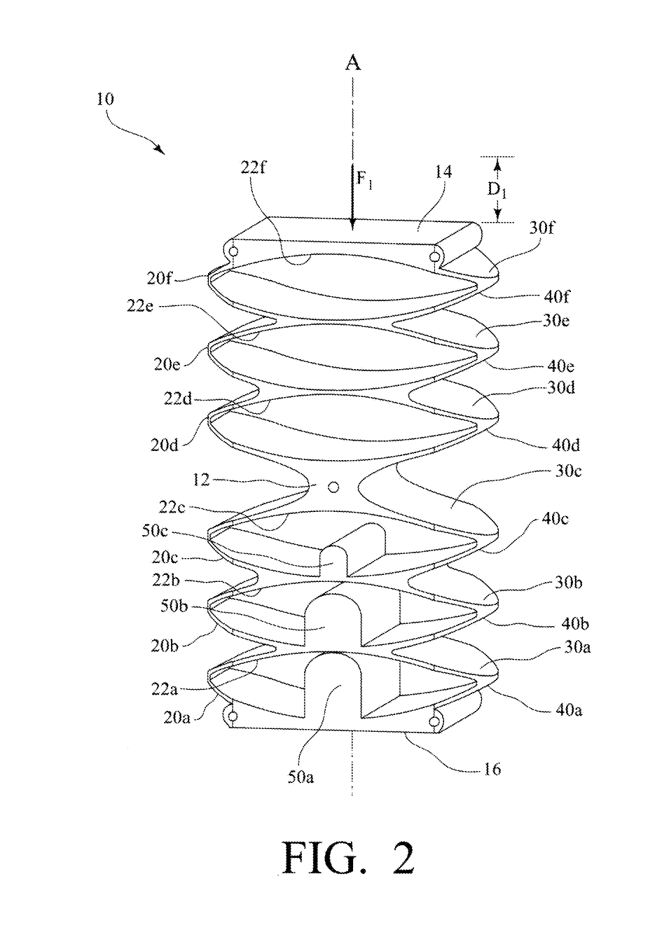

Accordingly, when a first predetermined force, F₁, is applied along Axis A of the spring 10, all of the spring elements 20a-f begin to compress simultaneously, and the spring 10 compresses at a constant spring rate according to the initial spring constant, K₁, until the spring 10 has compressed a first predetermined distance, D₁, as shown in FIG. 2. When the spring 10 is compressed the first predetermined distance, D₁, the upper member 30a of the first spring element 20a engages the first spring stop 50a positioned in the internal space 22a defined by the spring element 20a. In this way, the first spring stop 50a prevents the first spring element 20a from compressing any further. Thus, as shown in FIG. 2, the first spring element 20a is now inactive, and only the remaining active spring elements 20b-f are capable of compressing further.

For compression distances past the first predetermined distance, D₁, the spring 10 will compress according to a second effective spring constant, K₂, of the spring. The second spring constant, K₂, is based on the combination of the spring constants of the remaining active spring elements 20b-f that are still capable of compressing (i.e., all of the spring elements except for the first spring element 20a). In the exemplary spring 10, where each of the plurality of spring elements 20a-f is configured with the same spring constant, K, the second spring constant, K₂, is presumed to equal ⅕ of the spring constant, K, of the individual spring elements 20b-f.

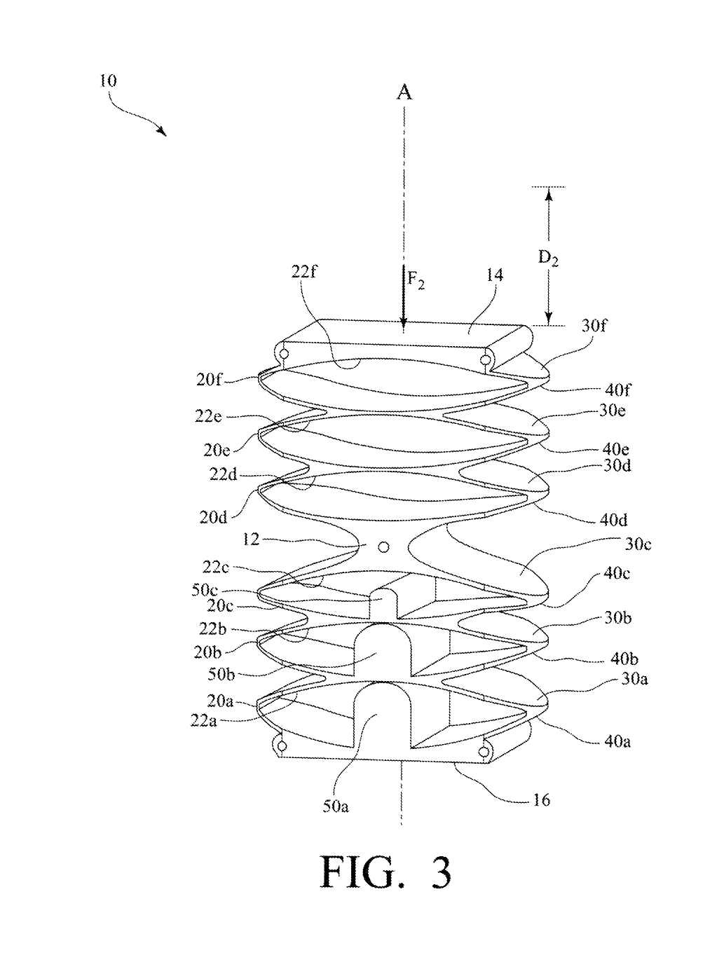

When a second predetermined (and greater) force, F₂, is applied along Axis A of the spring 10, all of the active spring elements 20b-f compress simultaneously, and the spring 10 will compress at a constant spring rate according to the second spring constant, K₂, until the spring 10 has compressed a second predetermined distance, D₂, as shown in FIG. 3. When the spring 10 is compressed the second predetermined distance, D₂, the upper member 30b of the second spring element 20b engages the second spring stop 50b positioned in the internal space 22b defined by the second spring element 20b. In this way, the second spring stop 50b prevents the second spring element 20b from compressing any further. Thus, as shown in FIG. 3, the first spring element 20a and the second spring element 20b are now inactive, and only the remaining active spring elements 20c-f are capable of compressing further.

For compression distances past the second predetermined distance, D₂, the spring 10 will compress according to a third effective spring constant, K₃ of the spring 10. The third spring constant, K₃, is based on the combination of the spring constants of the remaining active spring elements 20c-f that are still capable of compressing (i.e., all of the spring elements except for the first and second spring elements 20a, 20b). In the exemplary spring 10 where each of the plurality of spring elements 20a-f is configured with the same spring constant, K, the third spring constant, K₃, is presumed to equal ¼ of the spring constant, K, of the individual spring elements 20c-f.

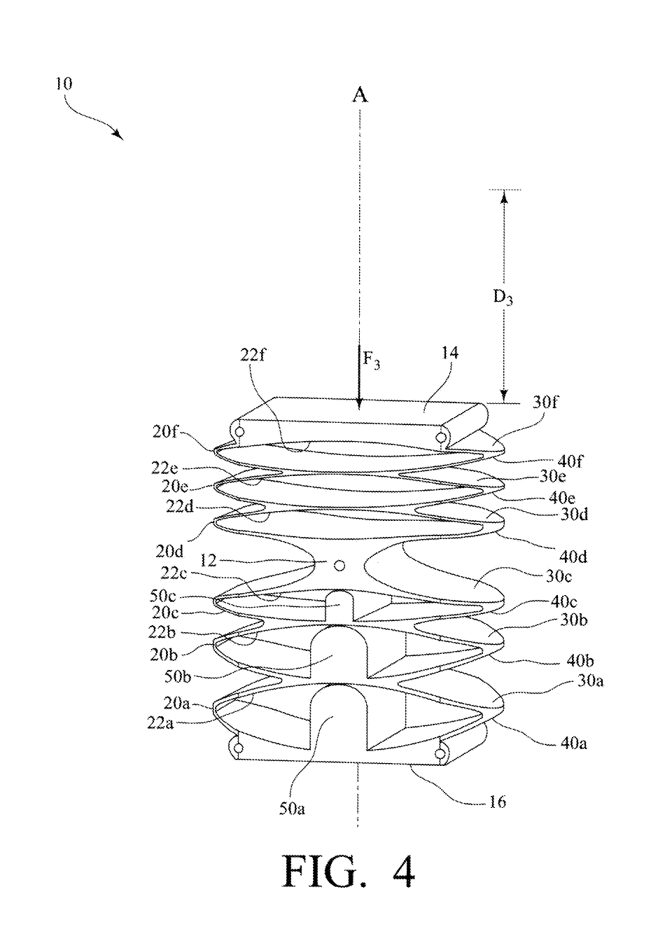

When a third predetermined (and greater) force, F₃, is applied along Axis A of the spring 10, all of the active spring elements 20c-f compress simultaneously, and the spring 10 will compress at a constant spring rate according to the third spring constant, K₃, until the spring 10 has compressed a third predetermined distance, D₃, as shown in FIG. 4. When the spring 10 is compressed the third predetermined distance, D₃, the upper member 30c of the third spring element 20c engages the third spring stop 50c positioned in the internal space 22c defined by the third spring element 20c. In this way, the third spring stop 50c prevents the third spring element 20c from compressing any further. Thus, as shown in FIG. 4, the first, second, and third spring elements 20a, 20b, 20c are now inactive, and only the remaining active spring elements 20d-f are capable of compressing further.

For compression distances past the third predetermined distance, D₃, the spring 10 will compress according to a fourth effective spring constant, K₄, of the spring 10. The fourth spring constant, K₄, is based on the combination of the spring constants of the remaining active spring elements 20d, 20e, 20f that are still capable of compressing (i.e., all of the spring elements except for the first, second, and third spring elements 20a, 20b, 20c). In the exemplary spring 10 where each of the plurality of spring elements 20a-f is configured with the same spring constant, K, the fourth spring constant, K₄, is presumed to equal ⅓ of the spring constant, K, of the individual spring elements 20d-f. It should be noted that, in this exemplary embodiment, the fourth spring constant, K₄, is thus twice the value of the initial spring constant, K₁, of the spring 10 when all of the spring elements 20a-f were active.

Although not shown, as more force is applied along Axis A of the spring 10 in excess of the third predetermined force, F₃, the fourth, fifth, and sixth spring elements 20d, 20e. 20f will simultaneously compress until the spring 10 reaches a maximum compression distance of the spring 10. In some embodiments, the maximum compression distance of the spring 10 occurs when the upper members 30d, 30e, 30f of the fourth, fifth, and sixth spring elements 20d, 20e, 20f are in direct contact with the respective lower members 40d, 40e, 40f, and there is a minimal, if any, internal space 22d, 22e, 22f defined by the fourth, fifth, and sixth spring elements 20d, 20e, 20f.

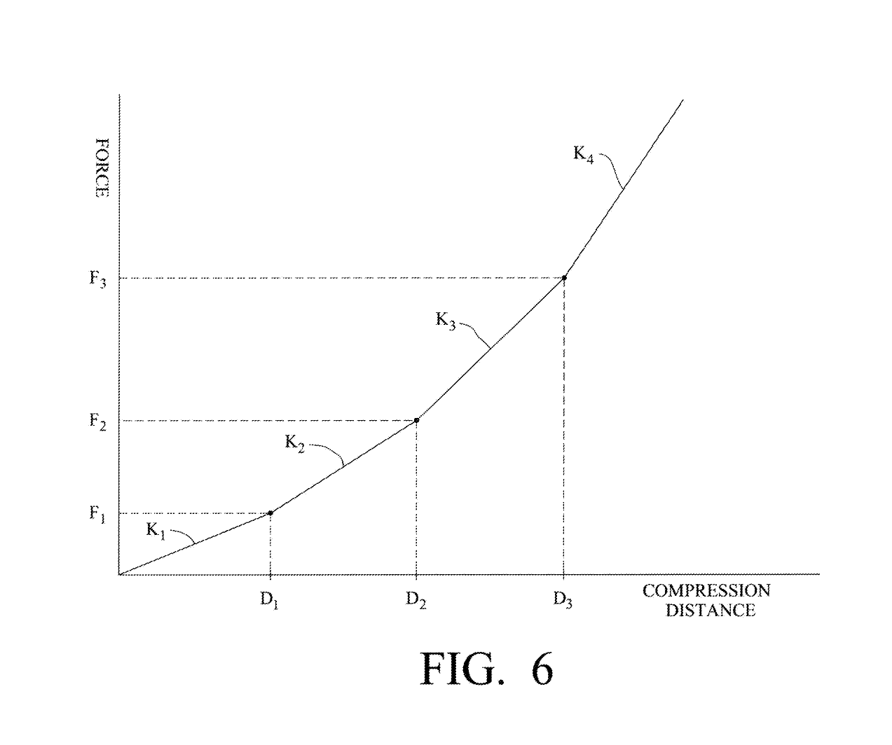

Referring again to FIG. 6, which graphically depicts the forces necessary to maintain compression distances of the spring 10, the effective spring constant of the spring 10 is the slope of the line at any given compression distance. Accordingly, as the force applied to the spring 10 increases and the compression distance of the spring 10 increases, the number of active spring elements decreases, and the effective spring constant of the spring 10 increases. As the spring constant increases (e.g., from K₁ to K₂), the spring rate also increases, and the spring 10 becomes “harder.” Thus, the spring 10 of the present invention provides a non-linear response to loading.

It should now be apparent that, by providing spring stops 50a-c of different sizes, each spring stop 50a-c engages its respective spring element 20a-c at different predetermined compression distances of the spring 10. In one particular embodiment of the present invention, the first spring stop 50a is sized such that the first predetermined distance, D₁, is 2 inches, the second spring stop 50b is sized such that the second predetermined distance, D₂, is 3 inches, and the third spring stop 50c is sized such that the third predetermined distance, D₃, is 4 inches. However, each particular spring element 20a-f and spring stop 50a-c can be configured to provide a spring 10 with any preferred compression response. For example, the spring 10 may be configured such that the first predetermined distance, D₁, is approximately 60% of the maximum compression of the spring, such that the spring 10 better mimics the support characteristics of a foam mattress.

With further respect to the size of spring 10 of the present invention, in certain embodiments, the dimensions of the spring 10 height can be analogous to what is observed in current metal springs which have a typical diameter between 50 mm to 80 mm, and which typically have a height ranging from about 250 mm to about 400 mm. However, these dimensions are based on height to base ratio limitations necessary to prevent a typical wire coil spring from becoming unstable. Due to its unique design, the spring 10 of the present invention is not limited by the same height to base ratio limitations of a typical wire coil spring and so it is also contemplated that the spring 10 may have a height to base ratio much greater than the ratio of a typical wire coil spring with dimensions outside of the ranges provided above.

It is also contemplated that the height of the spring slops 50a, 50b, 50c, in the spring 10 can also be tailored to provide a desired level of firmness in a mattress, such as the mattress described in further detail below. For instance, in producing a firm mattress, the spring stops 50a, 50b, 50c in the spring 10 can have a height that is closer to the overall pitch between each particular spring element 20a, 20b, 20c. In this regard, in a mattress where a person sinks further into the mattress, but gains support at a particular depth, such a mattress would have spring stop dimensions closer to one-half the pitch distance of a particular spring element. In other words, the height of each spring stop can readily be adjusted to produce a desired load deflection curve for an overall mechanical response of particular spring of the present invention.

Of course, the number of spring elements and spring stops may also be adjusted in order to develop the preferred compression response of the spring. Furthermore, in some embodiments, the spring stops may act as compression springs themselves. This may be accomplished by selecting a material for the spring stops which is itself compressible, or by forming the spring stops into a shape which would allow the spring stop to act as a compression spring. In such alternative embodiments, the spring constant of the spring would depend not only on which spring elements are currently engaged by the respective spring stops, but whether the particular spring stop is fully compressed itself. This provides yet another level of customization to further develop a preferred compression response of the spring.

Referring once again to FIGS. 1-4, regardless of the particular number or configuration of spring elements 20a-f and spring stops 50a-c, in this exemplary embodiment, the spring 10 further includes a substantially flat top engagement surface 14 extending from the upper member 30f of the sixth spring element 20f (i.e., the uppermost spring element) and a substantially flat bottom engagement surface 16 extending from the lower member 40a of the first spring element 20a (i.e., the lowermost spring element). The top and bottom engagement surfaces 14, 16 provide a larger contact surface for a force applied to the spring 10 which improves overall stability of the spring 10, as further described below.

Referring once again to FIG. 1-4, in this exemplary embodiment, the spring 10 also includes a vertical extension 12 that is positioned between the third and fourth spring elements 20c, 20d (i.e., the two middle spring elements). The vertical extension 12 is connected to the middle portion of the convex side of the upper member 30c of the third spring element 20c and the middle portion of the convex side of the lower member 40d of the fourth spring element 20d. In this way, the vertical extension 12 provides a similar connection between the third spring element 20c and the fourth spring element 20d as the general connection for adjacent spring elements 20a-20f described above; however, the vertical extension 12 provides greater spacing between the third and fourth spring elements 20c, 20d. Including the vertical extension 12 in the spring 10 provides a point of flexure in the spring 10 for when the spring 10 is asymmetrically loaded, as described in further detail below. Although the vertical extension 12 is shown in FIGS. 1-4 positioned between the third and fourth spring elements 20c, 20d, it is contemplated that the vertical extension 12 may be positioned between any two adjacent spring elements 20a-f, that more than one vertical extension 12 may be included in the spring 10, and that the vertical extension 12 can be provided at multiple heights to increase or decrease the overall height of the spring 10 itself without departing from the spirit and scope of the present invention.

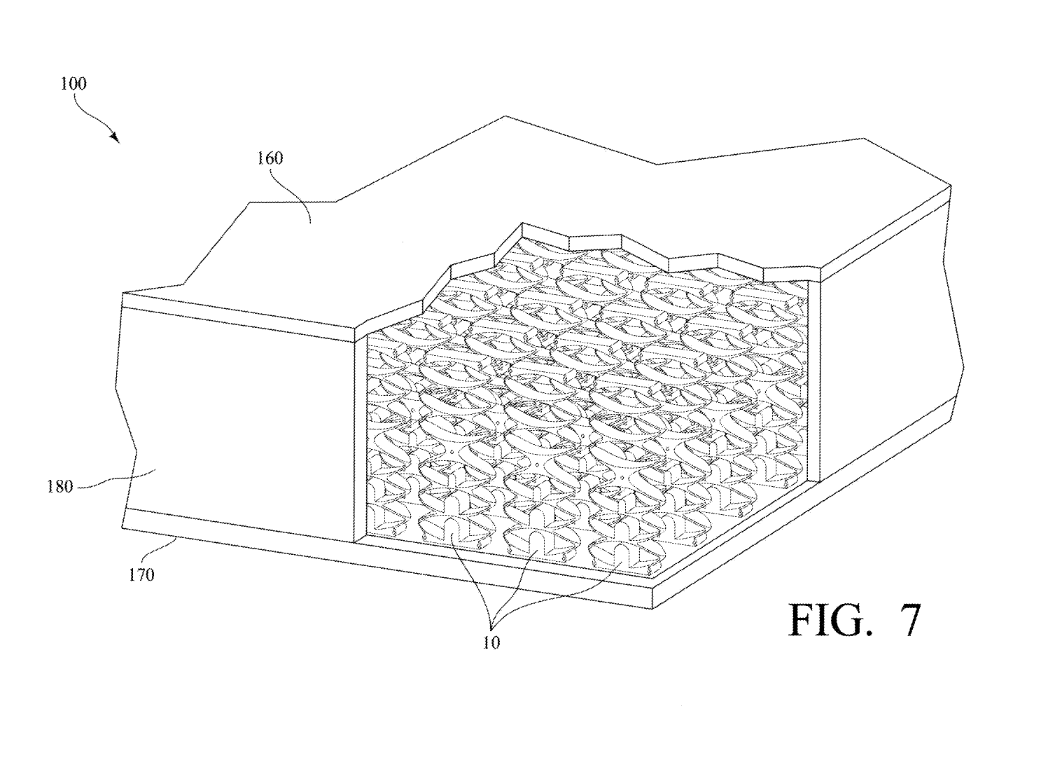

Referring now to FIG. 7, in another embodiment of the present invention, a mattress 100 includes a plurality of the springs 10 described with reference to FIGS. 1-4. The springs 10 are arranged in a matrix, such that the top engagement surfaces 14 of the springs 10 define a first support surface, and the bottom engagement surfaces 16 of the springs 110 define a second support surface opposite the first support surface. The mattress 100 also comprises an upper body supporting layer 160 positioned adjacent to the first support surface, along with a lower foundation layer 170 positioned adjacent to the second support surface. Furthermore, a sidewall 180 extends between the upper body supporting layer 160 and the lower foundation layer 170 around the entire periphery of the two layers 160, 170, such that the springs 10 are completely surrounded.

It is contemplated that the upper body supporting layer 160 is comprised of some combination of foam, upholstery, and/or other soft, flexible materials well known in the art. Furthermore, the upper body supporting layer 160 may be comprised of multiple layers of material configured to improve the comfort or support of the upper body supporting layer 160.

It is also contemplated that the lower foundation layer 170 could be similarly comprised of some combination of foam, upholstery, and/or other soft, flexible materials well known in the art, such that the mattress 100 can function no matter which way it is oriented. However, in other embodiments, the lower foundation layer 170 is comprised of a rigid member configured to support the plurality of springs 10.

Referring still to FIG. 7 when a user lays on the mattress 100 with a plurality of springs 10, it is unlikely that a given spring 10 will be loaded directly along Axis A as shown in FIGS. 1-4. To this end, it is contemplated that the vertical extension 12 allows the fourth, fifth and sixth spring elements 20d, 20e, 20f (i.e., the top three spring elements) to rotate relative to the first, second, and third spring elements 20a, 20b, 20c (i.e., the bottom three spring elements). In other words, the vertical extension 12 provides a pivot point between the fourth, fifth and sixth spring elements 20d, 20e, 20f and the first, second, and third spring elements 20a, 20b, 20c that allows the top engagement surface 14 more lateral movement. This allows the top engagement surface 14 of the spring 10 to maintain contact with the body supporting layer 160 as it conforms to a user's body, while simultaneously keeping the bottom engagement surface 16 of the spring 10 in firm contact with lower foundation layer 170 of the mattress 100.

It is contemplated that the spring 10 shown in FIGS. 1-4 is only one possible spring design exemplary of the present invention. It is contemplated that the spring of the present invention could also be a coil spring in this alternate embodiment, the coil spring is formed of a helically wrapped single strand of spring wire and includes a plurality of convolutions, or loops. Each convolution of the coil spring can be considered analogous to the spring elements 20a-f of the spring 10 described in reference to FIGS. 1-4. In this way, a spring stop may be positioned on one or more of the plurality of convolution and configured to prevent the convolution on which the spring stop is positioned from fully compressing. By providing spring stops of different sizes, each spring stop can engage its respective spring element at different compression distances of the spring and provide a non-linear response to loading as described above.

One of ordinary skill in the art will recognize that additional embodiments are also possible without departing from the teachings of the present invention or the scope of the claims which follow. This detailed description, and particularly the specific details of the exemplary embodiments disclosed herein, is given primarily for clarity of understanding, and no unnecessary limitations are to be understood therefrom, for modifications will become apparent to those skilled in the art upon reading this disclosure and may be made without departing from the spirit or scope of the claimed invention.

What is claimed is:

1. A spring, comprising:
a plurality of spring elements that are stacked atop one another, each spring element comprising an upper member and a lower member connected to the upper member, each spring element defining an internal space between the upper member and the lower member, and each spring element configured to compress when a force is applied to the spring, such that the upper member moves toward the lower member; and
one or more spring stops positioned in the internal space defined by the one or more of the plurality of spring elements.

2. The spring of claim 1, wherein each of the one or more spring stops is connected to a middle portion of the lower member of a respective one of the spring elements.

3. The spring of claim 1, wherein each of the one or more spring stops is configured to prevent a respective one of the spring elements from compressing past a predetermined compression distance.

4. The spring of claim 1, and further comprising a vertical extension positioned between two adjacent spring elements, such that the vertical extension is connected to the upper member of one of the two adjacent spring elements and to the lower member of the other of the two adjacent spring elements.

5. The spring of claim 1, and further comprising a top engagement surface extending from the upper member of an uppermost one of the plurality of spring elements and a bottom engagement surface extending from the lower member of a lowermost one of the plurality of spring elements.

6. A spring, comprising:
a plurality of spring elements that are stacked atop one another, each spring element comprising an upper member and a lower member connected to the upper member, each spring element defining an internal space between the upper member and the lower member, and each spring element configured to compress when a force is applied to the spring, such that the upper member moves toward the lower member;
a first spring stop positioned in the internal space defined by a first spring element and preventing the first spring element from compressing past a first predetermined compression distance; and
a second spring stop positioned in the internal space defined by a second spring element and preventing the second spring element from compressing past a second predetermined compression distance.

7. The spring of claim 6, wherein the first predetermined compression distance is different than the second predetermined compression distance.

8. The spring of claim 6, wherein the second spring stop is smaller than the first spring stop.

9. The spring of claim 8, and further comprising a third spring stop positioned in the internal space defined by a third spring element, wherein the third spring stop is smaller than the second spring stop.

10. The spring of claim 6, and further comprising a vertical extension positioned between two adjacent spring elements, such that the vertical extension is connected to the upper member of one of the two adjacent spring elements and to the lower member of the other of the two adjacent spring elements.

11. The spring of claim 6, and further comprising a top engagement surface extending from the upper member of an uppermost one of the plurality of spring elements and a bottom engagement surface extending from the lower member of a lowermost one of the plurality of spring elements.

12. A mattress, comprising:
multiple springs arranged in a matrix and defining a first support surface and a second support surface opposite the first support surface, with each of the multiple springs including
(a) a plurality of spring elements that are stacked atop one another, each spring element comprising an upper member and a lower member connected to the upper member, each spring element defining an internal space between the upper member and the lower member, and each spring element configured to compress when a force is applied to the spring, such that the upper member moves toward the lower member, and
(b) one or more spring stops positioned in the internal space defined by on one or more of the plurality of spring elements;
an upper body supporting layer positioned adjacent to the first support surface;
a lower foundation layer positioned adjacent to the second support surface; and
a sidewall extending between the upper body supporting layer and the lower foundation layer.
